(19) United States
(12) Patent Application Publication
(10) Pub. No.: US 2024/0078804 A1
(43) Pub. Date: Mar. 7, 2024

(54) GEOGRAPHIC LAND OPTIMIZATION SYSTEM AND METHOD

(71) Applicant: SSCT LLC, Muleshoe, TX (US)

(72) Inventors: Brett Bamert, Muleshoe, TX (US); Rob Cook, Farwell, TX (US)

(21) Appl. No.: 18/242,914

(22) Filed: Sep. 6, 2023

Related U.S. Application Data
(60) Provisional application No. 63/403,970, filed on Sep. 6, 2022.

(51) Int. Cl. G06V 20/10

(52) U.S. Cl. CPC G06V 20/188

(57) ABSTRACT

A land optimization recommendation data system wherein according to a user defined geographic area of interest global positioning system data corresponding to the user defined area in which one or more recommended seed blends are provided to the user via a graphical user interface, with the seed blends ranked according to historical data indicative of most prevalent plant life growth in the area of interest.

### CLAIM OF PRIORITY

This application claims priority to pending U.S. Provisional Application No. 63/403,970 filed Sep. 6, 2022, which is incorporated herein in its entirety.

### FIELD OF THE INVENTION

The present invention relates generally to commerce systems, and more specifically, to a land optimization system and method in which a user defined geographic boundary of a land area of interest invokes a graphical representation of a map of subregions within the boundary and associated soil types and ecological site information. Based at least in part on the boundary and subregions, a seed variety recommendation is generated, including seed amounts, derived from generated global positioning system coordinates stemming from the user defined geographic boundary.

### DESCRIPTION OF RELATED ART

Commerce systems are well known in the art and are effective means to enable multiple parties to exchange and leverage information, transfer goods, services, commodities and the like between them. Agencies concerned with land use, reclamation and optimization at the local, state and federal level collect data concerning local soil and growth conditions. Often, this information is gleaned from multiple, disparate sources. While the collection of this information is well-intended, it is often not put to use by those who need it most such as farmers, growers, reclamation companies, engineers, private land owners, and the like because the information is not placed in meaningful form, is difficult to collect or is otherwise not as helpful as it should be.

The data of interest for farmers and growers concerns climate and geography. That is, critical to the successful growth and cultivation of plant life is the climate of a particular location and the soil characteristics. While there may be resources available, such as the USDA's hardiness zone maps that inform users of what types of plants, grasses, etc. are ideal for a particular geographic zone of the country, this is only one part of the equation. Growers need to effectively and efficiently combine data collected by agencies, such as hardiness zone data, with other data specific to the grower's location in order to foster effective cultivation and land reclamation and preservation.

Accordingly, there is a need for systems and methods that efficiently aggregate information necessary for growers to achieve these ends.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a network diagram of which a land optimization platform is a part according to an embodiment;

FIG. 2 depicts a user interface of a land optimization platform according to an embodiment;

FIG. 3 is flowchart of a method performed by a land optimization platform according to an embodiment.

FIG. 4 depicts a user interface of a land optimization platform according to an embodiment;

FIG. 5 is flowchart of a method performed by a land optimization platform according to an embodiment.

While the systems and methods of the present application are susceptible to various modifications and alternative forms, specific embodiments thereof have been shown by way of example in the drawings and are herein described in detail. It should be understood, however, that the description herein of specific embodiments is not intended to limit the invention to the embodiments disclosed, but on the contrary, the intention is to cover all modifications, equivalents, and alternatives falling within the spirit and scope of the present application as defined by the appended claims.

### DETAILED DESCRIPTION OF THE EMBODIMENTS

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and methods in accordance with the present application overcome one or more of the above-discussed problems commonly associated with a conventional job bidding system and information systems where information is sourced to various entities. Specifically, the invention of the present application enables the collection of information pertinent to the information and bid request without sending a person to visit the location of the requested bid. In addition, the invention of the present application enables the collection of exact information pertinent to the requested information. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should also be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The embodiments herein described are not intended to be exhaustive or to limit the invention to the precise form disclosed. They are chosen and described to explain the principles of the invention and its application and practical use to enable others skilled in the art to follow its teachings.

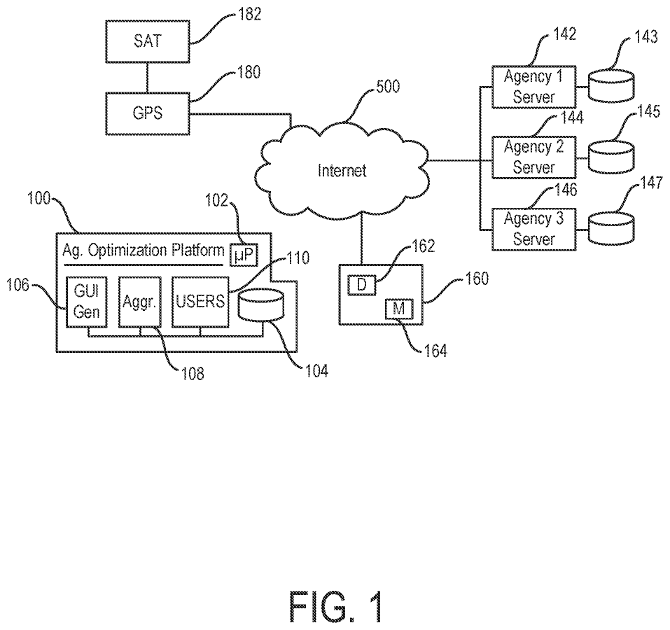

Referring now to the drawings wherein like reference characters identify corresponding or similar elements throughout the several views, FIG. 1 depicts a network in which a land optimization platform is a part and functions according to an embodiment of the present application. It will be appreciated that land optimization platform 100 overcomes one or more of the above-listed problems commonly associated with delivery and use of relevant land optimization and restoration related information.

In a contemplated embodiment, land optimization platform 100 includes at least one processor 102 in communication with one or more data stores 104. Processor 102 operates via an operating system and controls various components of land optimization platform 100, including graphical user interface module 106, aggregation module 108 and user module 110. Graphical user interface (GUI) module 106 employs hypertext mark up language (HTML) or similar protocols to generate a user interface that allows the user to enroll in land optimization platform 100 and enter information invoking aggregation via aggregation module 108 of data from multiple sources corresponding to the geographical location of the user's property. The user interface created for display to the user by GUI 106 also includes satellite image data and/or global positioning system (GPS) data based on information inserted by the user. Once the user inserts a property location of interest by graphically creating the boundary via the associated application programs retrieve the appropriate global positioning system coordinate data and retrieve the relevant satellite image of the property. This GPS and satellite imagery is retrieved from GPS server 180 and satellite imagery server 182 over a wide area network such as Internet 500. Once retrieved it is presented to the user via the created user interface that is presented to the user via a display screen associated with a computer, personal device, smart phone, tablet or the like.

The user interface generated by GUI module 106 includes satellite imagery of the geography or a map that includes the described property entered by the user and surrounding areas. The user may zoom in or out of the image to the extent made possible by the imagery retrieved by satellite imagery server 182. The user interface generated by GUI module 106 includes a pointer or drag and drop capability that enables the user to digitally draw a polygon or freehand shaped around all or a part of the property of interest. This can be performed via the mouse, touch screen, stylus or other display manipulation tools provided as part of the user's device. On a smart phone, for example, the described land optimization platform 100 is enabled on the smartphone by a dedicated application program downloaded to the device. The application program, which is executable code operating locally on the devices operating system, permits the user to access the various databases and features described herein that are accessible remotely via such distributed contexts such as the cloud via cellular network.

The user interface generated by GUI module 106 is displayed on display 162 of user device 160. User device 160 includes an associated manipulation device 164 that includes a mouse, a pointer, digital capture means, image editing means or the like, as known in the art. The user manipulates the mouse or other device to define a precise geographic boundary representing the area of the property under evaluation in part or in its entirety. In an embodiment the boundary encompasses property beyond the technical metes and bounds of the user's property.

Once the area of interest is entered or the user defines the precise geographic boundary of interest, land optimization platform 100 saves the designated “outlined” area in associated data store 104. Next, the platform 100 sends a request over Internet 500 or other communication network to the various agencies that have compiled data on the relevant property. In one embodiment, platform 100 sends via an application programming interface a request to one or more of agency servers 142, 144 and 146. Data stores 143, 145 and 147 in one embodiment are associated with agency servers 142, 144 and 146, respectively. In the alternative, agency servers may access data stored in data stores of other agencies to freely share information. Note that the Area of Interest (AOI) data is entered by the user as the physical address of the AOI, with the user outlining graphically the AOI or importing a shapefile of the AOI.

The various local, state, federal or private agencies collect agricultural data on a variety of topics, including site soil information, ecological site survey data, and historical weather and precipitation data. By example, the data can include the most effective grasses for growth in a particular area as well as recent pricing data, tonnage per species data and recommended stocking rates. The United States Department of Agriculture (USDA) is an agency that maintains a database of soil types based on testing or information gathered over time for a particular parcel or area or larger region. Also, universities having a robust agricultural department maintain various data concerning growth history. One such university, New Mexico State University, maintains the Ecosystem Dynamics Interpretive Tool (EDIT) in collaboration with the USDA's Natural Resource Conservation Service.

Based on the user's graphical representation, the area of the AOI is calculated, typically in acres. The user's selection corresponds to the geographical coordinates of the AOI. Data associated with the precise geographical location, that include the latitude and longitude of the user defined AOI boundaries invoke retrieval of underlying land data. Application programs dedicated to converting the user defined AOI convert the graphical selection to geographical coordinate data, uniquely identifying the area of interest. This converted graphical selection is then used to retrieve underlying soil and ecological data that is uniquely tied to the location.

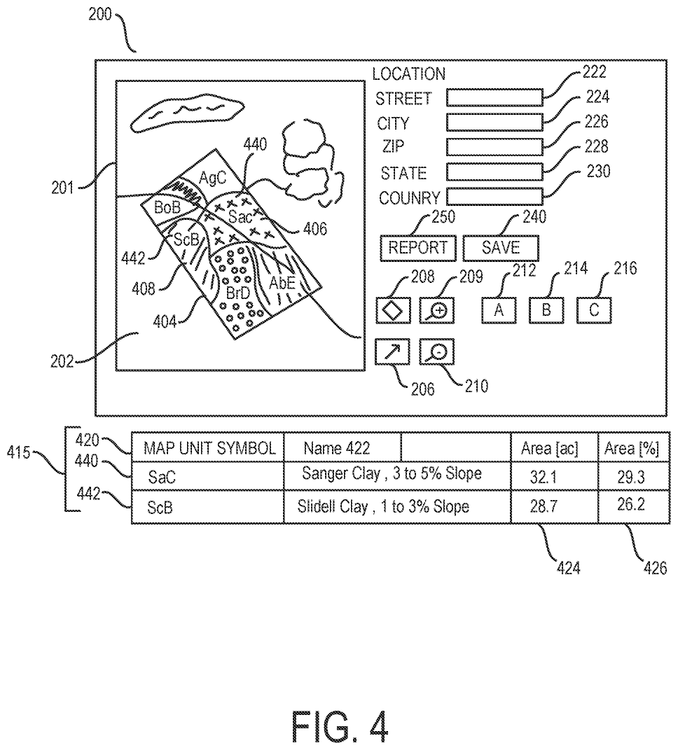

Soil data associated with an AOI incudes a map unit symbol that comprises a two-part, geographically shaped that uniquely identifies based on the user designated region a soil type as well as a slope percentage of the designated topography. As shown in FIG. 4, a designated AOI is segmented into regions, with each region having a designation representing a soil type and a slope. Data of the percentage of the area of each segment, and as each segment's percentage of the overall percentage of the entire AOI is provided as a result of the user's graphical designation.

Ecological site data retrieved corresponds to the several map unit segments for the designated AOL. Ecological site data comprises granular information corresponding to the AOI. Ecological site data is parsed in management units corresponding to the same or similar species components of growth in the user defined area. An AOI typically includes multiple ecological sites. Data associated with those ecological sites comprising at least five percent of the entirety of the AOI are provided to the user. The various sites are then prioritized or ranked according to the dominance of the specific growth within the AOI.

The user's graphical setting of an AOI via the presently described land optimization platform, are converted to GPS coordinates of the boundary. Underlying data such as Major Land Resource Area (MLRA) that is tied to particular geographic locations is accessed according to the user defined AOL. The user defined location will dictate what MLRA data will be retrieved. A corresponding seeding recommendation based on MLRA data is provided, which is a function of the underlying soil data and ecological site data that corresponds to the user graphically defined AOI.

In an embodiment, seeding recommendations are defined down to the species and variety of that species, according to commercial availability of the seed to the AOL. Seeding recommendations comprise a plurality of varieties and species, a blend recommendation by percentage for those blends most suitable for the AOI, ranked by highest percentage recommended first. This recommended blend percentage, by variety, corresponds to natural growth in the AOI, as the recommendation is to maintain or return the AOI to its natural growth state.

A recommended range for each listed seed species and variety, by percentage of the total number of seeds recommended is provided, from which the user selects a percentage, ideally within the range provided. With each recommended blend comes a pure live seed (PLS) seeding rate recommendation of the recommended number of pounds of the variety per acre. This results in a PLS blend seeding rate in pounds of blend per acre. Based on the acreage of the user defined geographic AOI, a quantity of the PLS blend needed for that seed for the AOI is provided.

Providing seed variety recommendations beyond just the species of seed according to the user defined geographical boundary provides users with more detailed and effective information for land optimization. In one embodiment the presently described land use optimization platform presents users with an activatable link with the in listing of species and variety. When activated, the link directs the user to a different uniform resource locator (URL) address of a webpage that provides information regarding the variety of the species selected.

Additionally, in an embodiment, a host of the land optimization platform 100 incorporates its own collected regional or location specific data to augment the data retrieved from agencies such as those described above.

Data collected from agencies tends to be static. That is, data in the EDITS database is typically indicative of plant life that was prevalent in the location of interest prior to any development of the land. On the other hand, some agencies update data concerning plant life and growth, providing a more dynamic source of information. Regardless of the nature of the base data, the land optimization platform described herein provides robust feedback to users concerning the optimal type of plant life conducive to the specific locale or recommendation of particular species of plant, grass, etc. and corresponding blend ratio/percentage. Finally, the land optimization platform provides the user with an option to purchase the recommended plant or grass species at the blend rate selected by the user. The platform would also recommend a vendor in the geographic region as a source to the user for the product. The user may opt to fill the order via the recommended vendor or download the order and submit it to its vendor of choice.

The various agencies that provide the data each have their respective strengths in terms of data provided, while some information is lacking. By example, while the USDA or EDITS provide generally reliable information regarding soil type in an area, this may not account for what types of plants or seed are actually available in the locality. The land optimization platform 100 described herein, however, bridges that gap by arriving at a recommended seed selection based not only on the ecological attributes of the area of interest, but also the commercial realities in the area in terms of what product is available. Thus, unlike the agency data which tends to be static, the land optimization platform 100 dynamically provides users with recommendations based on ever changing realities of the marketplace. In addition, unusual circumstances such as wet or dry seasons are also taken into account when the platform described herein provides a recommendation.

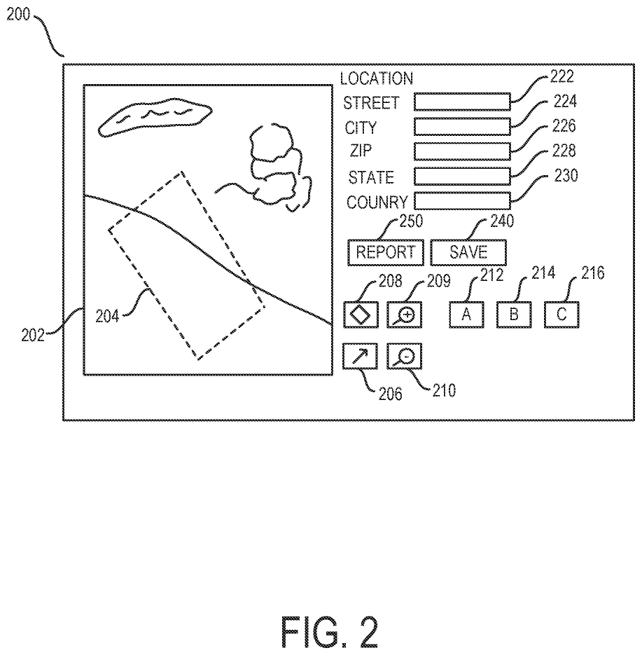

FIG. 2 depicts a graphical user interface of a land optimization platform according to an embodiment. GUI 200 in FIG. 2 is generated by GUI module 106 of FIG. 1. A user first participating in land optimization platform 100 establishes an account according to known practices. Typically, a user establishes a username, which can be a unique series of letters, numbers or special characters or an email address or mobile phone number. The user also sets a password, also comprised of letters, numbers or special characters. Once the user establishes an account, it is unique from the perspective of land optimization platform 100. In some embodiments, a user may create multiple subaccounts associated with one username. The user enrollment process is enabled by user module 110 of FIG. 1 and associated user information is stored in associated data store 104.

Once a user establishes an account and logs into land optimization platform 100 via entry of the username and password, GUI 200 is displayed on display screen 162 of the user device 160. In an embodiment, GUI 200 is comprised of various regions including map region 202. The contents of map region include a replication of a map of a particular location retrieved from a third-party provider, such as Google, provided in connection with the satellite imagery server 182 or the GPS server 180. Or, through a request directly over internet 500, the map image is received directly from the map provider. The user enters an address for the property of interest in various location fields. Street field 222, city field 224, zip code field 226, state field 228 and county field 230 are filled in by the user based on the location of the area of interest. Some or all of the information is sufficient, depending upon the level of granularity required by the platform host. County information pertains not only to the physical location of the property but will cause retrieval of pertinent data from any relevant agency within the county. The user activates save button 240 to store a particular address. This information is stored by land optimization platform 100 in data store 104.

Continuing with FIG. 2, other controllers within GUI 200 permit the user to view, manipulate and define a specific area within the map. As shown various keys are available via GUI 200 for activation by the user, including but not limited to pointer key 206, border key 208, zoom in key 209 and zoom out key 210. A user may decide to zoom in or out of map 202 to better define or even view the area of interest. By depressing the appropriate zoom key 209 or 210, the user sets the desired level of granularity. The user may once again activate save key 240, making this current iteration of the map part of the saved job.

In one embodiment, the user, using a computer mouse or other suitable device to control drawing of a boundary over map 200 displayed to the user via GUI 200, defines an area of interest (AOI) by “drawing” or outlining a boundary over map 200. The user created boundary is converted to a unique set of GPS coordinates identifying the boundary, the interior region of which serves as the catalyst to the soil and ecological site information generated and presented to the user, as well as the resulting recommended seed blends and report generation.

Note that platform 100 optionally provides a three-dimensional map that is rotatable and tiltable by the user via GUI 200. This permits the user to view precisely the landscape of area at issue, which is particularly useful to account for shading, drainage, elevated areas and the like as plant and seed decisions are made. GUI 200 includes display 201 for which includes map 200. Map 200 is imported via known mapping application programs, or can be set by entry of a street, city or state, a zip code, or known address, with the depiction of the area including a designated radius from the selected place. GUI 200 also includes zoom in and zoom out keys 209 and 210, respectively, allowing the user to take an expanded or narrow view of the location.

Once map 202 is set, the user may activate pointer key 206. Pointer key 206 enables the user to select a starting point for designating a boundary. Pointer key 206 may also be used to select a pre-defined boundary as in some municipalities, property lines are provided on county land development maps. In some embodiments, land optimization platform 100 provides the user with the option to select the map source from various websites or external databases.

Once pointer key 206 is activated, the user designates a starting point on map 202 to create a boundary. Once a point is set, the user activates border key 208. Activation of border key 208 causes a polygon shaped border 204 to appear on map 202. Border or user defined area of interest (AOI) 204 has a corresponding set of GPS coordinates that define the boundary in terms of its global coordinates. It is these global coordinates that drive the retrieval, presentation and processing of land data for the land within the user define boundary. At this stage, the user may expand or contract the border by a common dragging technique using the computer mouse, stylus or the like. Once the desired boundary is set, the user may once again save key 240, which causes this version of map 202 with finalized border 204 to be saved in data store 104.

Once the user's defined boundary is set, the user may depress report key 250. Report key causes land optimization platform 100 to retrieve various agency information from agency servers 142, 144 and 146 pertaining to the data concerning the land parameters set by the user via GUI 200.

Next, aggregation module 108 (FIG. 1) is invoked to compile data received from agency servers 142, 144 and 146. Aggregation module 108 comprises software that in addition to compiling agency and/or third-party information determines an optimal ratio of various plant of grass seed blends appropriate for that particular locale, based on the commercial availability of those plants or seeds at or near the location as well as any other anomalies that may persist at that time. Such anomalies include unusual weather conditions, such as drought, excess rain, flooding or other environmental conditions.

In an embodiment, optionally via GUI 200 the user may select one or more of source keys 212, 214 and 216. These source keys are assignable by the land optimization platform administrator to a particular resource. Source keys act as links that when activated or invoked by the user on GUI 200 with a selection device, such as a mouse, directs the user to various data generated according to the user defined AOL. Such data includes soil and ecologincal site information, seeding recommendations and report creation. Source keys 212, 214 and 216 in one embodiment are links that direct the user to various data that is created according to the GPS coordinates of the user defined AOI through the GUI.

Following aggregation module 108 determining a recommended amount and type of plant or seed and the blend percentage of such a report in usable form is submitted to the user via GUI 200. The report may be in a spreadsheet such as in Microsoft Excel, or in .pdf or other form that may be manipulated, exported or otherwise used by the user. The report is saved in data store 104 and may be saved in local or remote computer storage by the user.

FIG. 4 depicts GUI 200 described in FIG. 2 once a user has defined a boundary for an AOL. In FIG. 4 GUI 200 is similar to that described in connection with FIG. 2, with map 200 depicted within display 201 of GUI 200. User defined AOI 404 is and is parsed into various subregions according to the soil type and topographical slope of each subregion. As shown, user defined AOI 404 includes six subregions. The number of subregions generated is dictated by the soil type and slope of the entire area within the boundary. In theory, a user defined AOI could include one subregion, meaning the entirety of the AOI is comprised of a single type of soil and has a uniform slope or grade. In the example shown, a first subregion 406 includes a first identifier 440 SaC and a second subregion 408 includes a second identifier 442 ScB. In one embodiment, the prefix of the identifier denotes the soil type and the suffix of the identifier denotes the slope or grade of that geographic subregion. Each subregion in an embodiment is color coded or shaded to graphically differentiate one subregion from a neighboring subregion. This enables the user to better understand which soil type and slope correspond to a particular sub-area of interest or item within a subregion, such as buildings, farms, planned development or the like. Soil data and ecological site data refer to numerous pieces of information concerning the geographic location compiled and maintained by many sources.

Continuing with FIG. 4, in one embodiment table 415 is generated that corresponds to user defined AOI 404 and the various subregions therein. As shown, table 415 contains information associated with first subregion 406 and second subregion 408 and includes data concerning first identifier 440 (SaC) and second identifier 442 (ScB) Name field 422 includes the name of the soil, which corresponds to the prefix of the identifier. In the case of first identifier 440, the soil name “Sanger clay” corresponds to prefix Sa. For second identifier 442, the soil name “Slidell clay” corresponds to prefix Sb. Also in name field 422 is the slope or grade of the subregion. For first identifier 440, suffix C denotes a 3-5 percent slope of the underlying land. For second identifier 442, suffix B denotes a 1-3 percent slope of the underlying land.

Table 415 also includes area field 424. Area field includes the acreage of the subregion. In this example, subregion 406 covers 32.1 acres and subregion 408 covers 28.7 acres. Area percentage field 426 includes table entries denoting what percentage the subregion occupies of the entirety of user defined AOI 404. The administrator of land optimization platform 100 may designate other fields regarding attributes of user defined AOI 404, a subregion or the like, as desired.

The presently described land optimization platform provides a technological advance in the retrieval, processing and use of predefined data concerning land usage and composition. The graphical user interface described herein incorporates GPS data that uniquely identifies a boundary of an AOI selected by the user. Based on the user selection, graphical image data is generated and displayed, presenting selectable subregions of the user defined AOI. Graphical representation of soil composition and topology slope or grade selectably displayed and parsed on the graphical user interface presents the user with detailed AOI information, with more detailed information available. Based on the AOI designation and subregion creation, the user receives customizable recommendation data which corresponds to historical growth data for the AOI and each associated subregion. The user customizes the recommendation data according to a selected seed blend percentage, resulting in a recommended blend seeding rate in lb./acre and a total blend seed amount required for each seed variety for the AOI in pounds. The graphical user interface and boundary selection capability, and the global positioning coordinates associated therewith are a technical improvement over prior art data base systems and data processing drive the retrieval, selection and processing of the underlying land data.

The various capabilities described herein reside in various software modules or application programs having executable program instructions stored in memory of a user device or remotely in one or more storage locations that are accessible by a properly credentialed user. The various applications programs direct generation of the GUI and carry out user commands related to AOI generation, data saving, table generation, feature selection and the like.

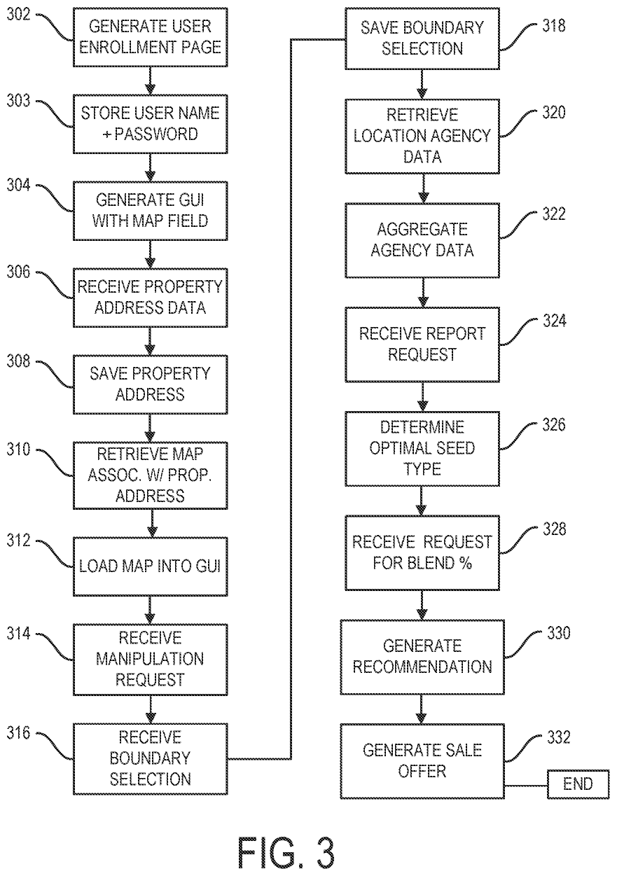

FIG. 3 is a flowchart of a method performed via land optimization platform 100. The method of FIG. 3 starts at step 302 where land optimization platform 100 generates a user enrollment page for a new user of the platform. This is generated by GUI generator 106 and presented to the user on the user's personal device 160 via display 162. Next at step 303, the user enters a username and password stored in data store 104 associated with user module 110. Then at step 304 GUI module 106 generates a GUI image of the type shown in FIG. 2 that includes a region for a map of a location entered by the user in the appropriate fields, as described in connection with FIG. 2. Once the user saves property address data, it is received by the platform at step 306 and saved in data store 104.

Once the property location data is saved, at step 310 a map is retrieve that encompasses the saved address. As discussed, the platform may retrieve a map from known sources such as Google maps, or from municipal map sources or the like. Then at step 312 the platform causes the retrieved map to be loaded into GUI 200.

At step 314 following loading of the map, the user can invoke the various map manipulation keys, which in turn invokes a map manipulation request. This manipulation request is in the form of user activation of the zoom in key 209 or zoom out key 210, or pointer 206 or boundary key 208 or any combination thereof. Once the user ultimately achieves the desired layout and granularity of map 202, the user sets a boundary of interest via pointer key 206 and boundary key 208 activation as discussed above. Once the user expands, rotates, contracts or otherwise manipulates the boundary 204 overlaying map 202, the user selects the save key, at which point the method proceeds to step 316 where the platform receives the boundary selection and saves it in data store 104 at step 318.

Based on the saved boundary data, platform 100 retrieves GPS coordinate data based on the location. Then at step 320 platform 100 retrieves agency data from agency servers 142, 144 and 146. Alternatively, platform 100 retrieves data from the designated sources assigned to source keys 212, 214 and 216. Regardless of the source or sources, at step 322 aggregation module 108 aggregates the collected data concerning the property, such as soil characteristic data, historic plant data and the like as collected from the various sources.

Once the data is collected, platform 100 enables user selection of generate report key 250. Once activated by the user, at step 326 platform 100 determines an optimal plant or seed type for the particular location. Once the user receives the report, the user can further request a recommendation for a blend percentage for various seeds, such as grass seed, forbs and pollinators most fitting for the location. Next, in response to the request, platform 100 generates a recommendation at step 330 of a blend percentage and plant type conducive to the set location. This recommendation is based on the data retrieved from the agencies but also intelligence gathered by or for platform 100 that includes particular environmental conditions that require modification of the base recommendation as well as commercial availability of recommended seeds or plants.

Once a recommendation is generated and sent to the user via GUI 200 or other delivery means, such as email or the like, a sale offer is generated at step 332 ending the process. The sale offer includes various commercial entities through whom the recommended plants or seeds can be purchased, pricing options, and the like.

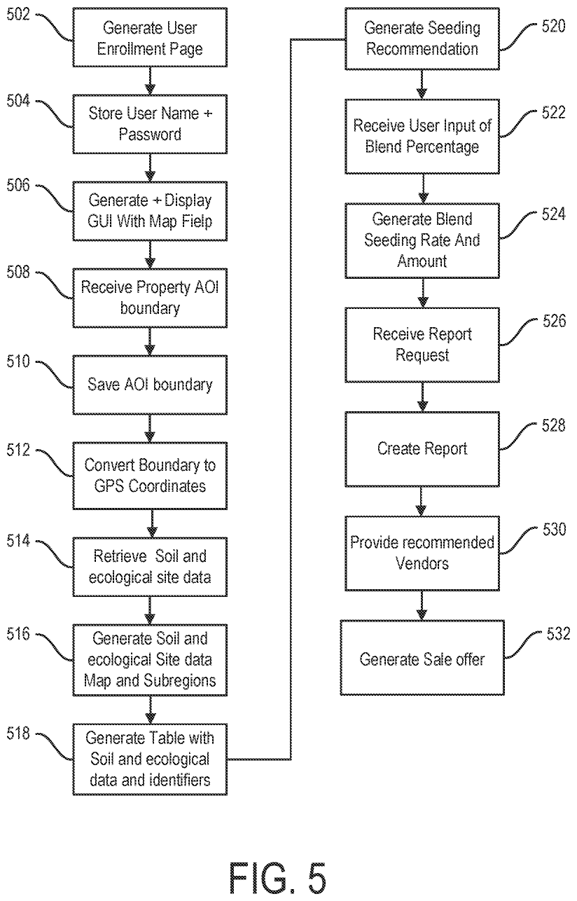

FIG. 5 is a flowchart of a method performed by a land optimization platform according to an embodiment. The method of FIG. 5 begins at step 502 where a user enrollment page is generated for permitting a user to create an account to access and use the land optimization platform. Next at step 504, the platform stores the user selected name and password, which together uniquely identify the user. Then at step 506 once the user is enrolled in the platform, a GUI with a map field is generated and displayed to the user on the user device. The GUI also include selectable command buttons or the like that a user selects to create an AOL. At step 508, the platform receives a user selected AOI, achieved through the boundary drawing capability of the platform. This capability is achieved through a digital pointer that is manipulated by computer mouse, mousepad, computer or device keys, screen swipes, or the like. This created AOI border is presented in real time when created or drawn by the user on the display area of the GUI.

Once the user is satisfied with the boundary of the AOI, the platform stores the user defined boundary at step 510. Next at step 512 the platform converts the user defined boundary of the AOI to its GPS coordinates. In one embodiment, the platform communicates with a third-party GPS location service. Alternatively, the platform includes its own GPS location identification software and capability. Next at step 514, the platform retrieves and aggregates soil and ecological site data for the AOL. This data is retrievable from one or a plurality of sources. Next, at step 516 the platform generates a soil an ecological site data map for presentation on the GUI display region. This data map includes one or more subregions within the user defined AOI. The subregions are depicted graphically and in one embodiment in contrasting colors or patterns to clearly define and display boundaries between subregions. The generated subregions include identifiers that uniquely define soil type and land slope or grade associated with that subregion. The subregions and identifiers are selectable by the user to direct the user to information concerning the subregion's attributes contained in a table.

Next at step 518, the platform generates a table with soil and ecological site data corresponding to the identifiers of the subregion. The table includes various fields that include soil name, slope or grade of the topography of the land of the subregion, the total area of the subregion and the percentage of area of the entire AOI that the subregion comprises. Next at step 520 the platform generates a recommendation for seeding that is displayed to the user. The recommendation, in one embodiment, includes a range of recommended blends of specific seed varieties appropriate for the AOL. In one embodiment, only plant life having growth that occupies at least five percent of the AOI is included in the recommendation, but the administrator may set higher or lower thresholds. The recommended seed blends are listed according to most prevalent growth to the least, but the administrator may set other methods of prioritization. The recommendation includes a recommended pure live seed (PLS) seeding rate in pounds per acre for the various varieties.

At step 522 the platform receives user input in the form of a selected blend percentage. Here, the user selects a range, ideally within the recommended blend range, to maintain or return the AOI to its natural and historical growth state. Based on the blend percentage received by the user, at step 524 the platform defines a blend PLS seeding rate in pounds per acre for the AOI and a finite amount in pounds of the PLS seed required.

Continuing at step 526, the platform receives a user request for a report and at step 528 the platform creates a report and stores it in local or remote storage. While processing the report, at step 530 the platform provides a recommended vendor. The recommended vendor in one embodiment is only the administrator of the platform. In other embodiments, the platform provides a recommendation of any vendor within a predefined radius of the user through which the selected seed blend(s) are available. Finally, at step 532, an offer including pricing for the seed blend(s) are displayed to and downloadable by the user.

The above-described methods and systems and can be implemented in a software module, a software and/or hardware testing module, a telecommunications test device, a DSL modem, an ADSL modem, an xDSL modem, a VDSL modem, a linecard, a G·hn transceiver, a MOCA transceiver, a Homeplug® transceiver, a powerline modem, a wired or wireless modem, test equipment, a multicarrier transceiver, a wired and/or wireless wide/local area network system, a satellite communication system, network-based communication systems, such as an IP, Ethernet or ATM system, a modem equipped with diagnostic capabilities, or the like, or on a separate programmed general purpose computer having a communications device or in conjunction with any of the following communications protocols: CDSL, ADSL2, ADSL2+, VDSL1, VDSL2, HDSL, DSL Lite, IDSL, RADSL, SDSL, UDSL, MOCA, G·hn, Homeplug® or the like.

Additionally, the systems, methods and protocols of this invention can be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable means, or the like. In general, any device (or one or more equivalent means) capable of implementing a state machine that is in turn capable of implementing the methodology illustrated herein can be used to implement the various communication/measurement methods, protocols, and techniques according to this invention.

Furthermore, the disclosed methods may be readily implemented in software stored on a non-transitory computer-readable storage media using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

### Additional Disclosure

Further written description is provided by the following clauses.

Clause 1. A system for generating information concerning land, comprising:
a memory;
a processor coupled to the memory programmed with executable instructions, the instructions including a graphical user interface for selection and display of a map boundary containing a land area of interest for obtaining geographic location-specific information for a plurality of land subregions within the map boundary, wherein the geographic location-specific information comprises land soil data and topographical slope data uniquely associated with each of the plurality of land subregions, a recommended seed variety blend percentage, a recommended pure live seeding rate and a recommended user defined selected blend percentage; and a global positioning system (GPS) coordinate retrieval interface for assigning GPS coordinates to the map boundary, wherein the graphical user interface includes (a) a user selectable boundary selector for designating the map boundary for display on a display sector of the graphical user interface; and (b) user selectable graphical subregions corresponding to a portion of the land area of interest within the designated map boundary, the selection of which causes display of the land soil data, topographical slope data and an area of the subregion.
   Clause 2. The system generating information concerning land of any preceding or proceeding clause, wherein the subregion comprises a selectable identifier that uniquely identifies a soil type and a topographical slope percentage attributable to each subregion.
   Clause 3. The system for generating information concerning land of any preceding or proceeding clause, wherein a first subregion is coded in a manner differentiating the first subregion to a second subregion.
   Clause 4. The system for generating information concerning land of any preceding or proceeding clause, wherein the processor generates a table within the graphical user interface corresponding to the selectable identifier of one or more of the subregions.
   Clause 5. The system for generating information concerning land of any preceding or proceeding clause, wherein the recommended seed blend percentage comprises a range for each of one or more seed varieties optimally associated with the global positioning system coordinates of the land area of interest.
   Clause 6. The system for generating information concerning land of any preceding or proceeding clause, wherein the recommended seed blend is displayed within the graphical user interface in an order according to a most prevalent historical growth data, by percentage, associated with the GPS coordinates of the land area of interest.
   Clause 7. The system for generating information concerning land of any preceding or proceeding clause, wherein the recommended seed blend displayed within the graphical user interface is limited to a user defined threshold set according to a minimum amount of historical growth data, by percentage, associated with the GPS coordinates of the land area of interest.
   Clause 8. The system for generating information concerning land of any preceding or proceeding clause, wherein the recommended user defined selected blend percentage is associated with a pound per acre blend pure live seed rate for a seed variety for the land area of interest.
   Clause 9. The system for generating information concerning land of any preceding or proceeding clause, wherein the recommended user defined selected blend percentage is associated with a total amount of blend pure live seed necessary for the land area of interest.
   Clause 10. A method for generating information concerning land, comprising:
establishing a subscribing member user account;
enabling a graphical user interface having a land area of interest boundary generating tool for user selection of the land area of interest;
receiving a user drawn boundary surrounding the land area of interest in a display area of the graphical user interface drawn by the generating tool;
displaying the user drawn boundary within the display area of the graphical user interface; retrieving global positioning system (GPS) coordinates associated with the user drawn boundary;
accumulating land data, comprising a soil type and a topography slope percentage corresponding to the retrieved GPS coordinates; and
displaying a recommended a seed species and variety blend percentage range most conducive to growth corresponding to the retrieved GPS coordinates.
   Clause 11. The method of any preceding or proceeding clause, further comprising the step of receiving from a user a selected blend percentage within the seed species and variety blend percentage range.
   Clause 12. The method of any preceding or proceeding clause, further comprising displaying of a blend pure live seeding rate in units of weight per area corresponding to the user selected blend percentage of the seed species and variety.
   Clause 13. The method of any preceding or proceeding clause, further comprising displaying of a blend pure live seeding amount in a unit of weight for the area of interest corresponding to the user selected blend percentage of the seed species and variety.
   Clause 14. The method of any preceding or proceeding clause, wherein display of the recommended seed species and variety blend percentage ranges are ranked from the plant life most conducive to growth corresponding to the retrieved GPS coordinates and according to historical data indicative of a most prevalent plant life growth in the land area of interest to a least prevalent plant life growth in the land area of interest corresponding to the retrieved GPS coordinates and according to historical data indicative of less prevalent plant life growth.
   Clause 15. The method of any preceding or proceeding clause, wherein the pure live seeding rate is predefined according to the seed species and variety corresponding to the GPS coordinates of the land area of interest.
   Clause 16. The method of any preceding or proceeding clause, further comprising parsing the displayed user drawn boundary into subregions according to differences in the soil type and the topography slope percentage across the user drawn boundary of the land area of interest and displaying the subregions to the user in the display area of the graphical user interface.
   Clause 17. The method of any preceding or proceeding clause, wherein the subregions include user selectable identifiers that identify the soil type and topography slope percentage.
   Clause 18. The method of any preceding or proceeding clause, further comprising receiving a report request from the user requesting a report including a potential seller of the recommended seed blend.
   Clause 19. The method of any preceding or proceeding clause, wherein seed species and variety blend percentage ranges are provided for plant life occupying more than a predefined minimum percentage of overall plant life growth in the land area of interest.

What is claimed is:

1. A system for generating information concerning land, comprising:
a memory;
a processor coupled to the memory programmed with executable instructions, the instructions including a graphical user interface for selection and display of a map boundary containing a land area of interest for obtaining geographic location-specific information for a plurality of land subregions within the map boundary, wherein the geographic location-specific information comprises land soil data and topographical slope data uniquely associated with each of the plurality of land subregions, a recommended seed variety blend percentage, a recommended pure live seeding rate and a recommended user defined selected blend percentage; and a global positioning system (GPS) coordinate retrieval interface for assigning GPS coordinates to the map boundary, wherein the graphical user interface includes (a) a user selectable boundary selector for designating the map boundary for display on a display sector of the graphical user interface; and (b) user selectable graphical subregions corresponding to a portion of the land area of interest within the designated map boundary, the selection of which causes display of the land soil data, topographical slope data and an area of the subregion.

2. The system generating information concerning land of claim 1, wherein the subregion comprises a selectable identifier that uniquely identifies a soil type and a topographical slope percentage attributable to each subregion.

3. The system for generating information concerning land of claim 2, wherein a first subregion is coded in a manner differentiating the first subregion to a second subregion.

4. The system for generating information concerning land of claim 2, wherein the processor generates a table within the graphical user interface corresponding to the selectable identifier of one or more of the subregions.

5. The system for generating information concerning land of claim 1, wherein the recommended seed blend percentage comprises a range for each of one or more seed varieties optimally associated with the global positioning system coordinates of the land area of interest.

6. The system for generating information concerning land of claim 1, wherein the recommended seed blend is displayed within the graphical user interface in an order according to a most prevalent historical growth data, by percentage, associated with the GPS coordinates of the land area of interest.

7. The system for generating information concerning land of claim 1, wherein the recommended seed blend displayed within the graphical user interface is limited to a user defined threshold set according to a minimum amount of historical growth data, by percentage, associated with the GPS coordinates of the land area of interest.

8. The system for generating information concerning land of claim 1, wherein the recommended user defined selected blend percentage is associated with a pound per acre blend pure live seed rate for a seed variety for the land area of interest.

9. The system for generating information concerning land of claim 1, wherein the recommended user defined selected blend percentage is associated with a total amount of blend pure live seed necessary for the land area of interest.

10. A method for generating information concerning land, comprising:
establishing a subscribing member user account;
enabling a graphical user interface having a land area of interest boundary generating tool for user selection of the land area of interest;
receiving a user drawn boundary surrounding the land area of interest in a display area of the graphical user interface drawn by the generating tool;
displaying the user drawn boundary within the display area of the graphical user interface;
retrieving global positioning system (GPS) coordinates associated with the user drawn boundary;
accumulating land data, comprising a soil type and a topography slope percentage corresponding to the retrieved GPS coordinates; and
displaying a recommended a seed species and variety blend percentage range most conducive to growth corresponding to the retrieved GPS coordinates.

11. The method of claim 10, further comprising the step of receiving from a user a selected blend percentage within the seed species and variety blend percentage range.

12. The method of claim 11, further comprising displaying of a blend pure live seeding rate in units of weight per area corresponding to the user selected blend percentage of the seed species and variety.

13. The method of claim 12, further comprising displaying of a blend pure live seeding amount in a unit of weight for the area of interest corresponding to the user selected blend percentage of the seed species and variety.

14. The method of claim 10, wherein display of the recommended seed species and variety blend percentage ranges are ranked from the plant life most conducive to growth corresponding to the retrieved GPS coordinates and according to historical data indicative of a most prevalent plant life growth in the land area of interest to a least prevalent plant life growth in the land area of interest corresponding to the retrieved GPS coordinates and according to historical data indicative of less prevalent plant life growth.

15. The method of claim 12, wherein the pure live seeding rate is predefined according to the seed species and variety corresponding to the GPS coordinates of the land area of interest.

16. The method of claim 10, further comprising parsing the displayed user drawn boundary into subregions according to differences in the soil type and the topography slope percentage across the user drawn boundary of the land area of interest and displaying the subregions to the user in the display area of the graphical user interface.

17. The method of claim 16, wherein the subregions include user selectable identifiers that identify the soil type and topography slope percentage.

18. The method of claim 10, further comprising receiving a report request from the user requesting a report including a potential seller of the recommended seed blend.

19. The method of claim 14, wherein seed species and variety blend percentage ranges are provided for plant life occupying more than a predefined minimum percentage of overall plant life growth in the land area of interest.
